(19) United States
(12) Patent Application Publication
(10) Pub. No.: US 2007/0011289 A1
(43) Pub. Date: Jan. 11, 2007

(54) Apparatus and method for providing notice of expiration of a trial period

(75) Inventor: Yoshimitsu Goto, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/147,441

(22) Filed: Jun. 8, 2005

(51) Int. Cl. G06F 15/173

(52) U.S. Cl. 709/223

(57) ABSTRACT

An apparatus and method for collecting information including an amount of use of the trial function during a trial period, generating a notification including the collected information at a predetermined time, and sending the notification to a predetermined location. The trial period can be a specified amount of time, or a number of uses of the trial function or a specified number of pages.

### FIELD OF THE INVENTION

The present invention relates generally to multi-function peripherals (MFPs) and, more particularly, to a system and method for providing notice of the expiration of a trial period for using an MFP function.

### BACKGROUND OF THE INVENTION

In recent years, the use of multi-function peripherals (MFPs) has become increasingly prevalent. MFPs provide users with a multiplicity of functions including printing, copying, faxing, scanning, document management, and other functions. Any particular MFP may include all of these functions, or some subset of these functions. In addition to these high-level functions, the MFPs also can offer some more specialized functions that typically combine the high-level functions of the MFP. For example, a specialized function may be a scan-to-email function in which the MFP scans a document and e-mails the scanned document to one or more recipients. Another specialized function can be a scan-to-print function in which the MFP scans a document and prints the scanned image.

When an MFP is purchased, specialized functions like the scan-to-email and scan-to-print functions may not be enabled and typically require a fee to enable and use them. In many environments, such functions are either not used or only used infrequently. To encourage the use, the MFP manufacturer may arrange for a trial period in which the user can use the function for a certain period of time, for a certain number of times, or for a certain volume of use (e.g., number of pages printed). To enable the use of the function for the trial period, a serviceman typically goes to the user location and configures the MFP according to the agreed upon trial period and function.

In this trial system, the serviceman and manufacturer are not able to monitor the use of the trial function without visiting the user site. Further, if the trial period is for a certain number of uses of the function, then the serviceman and manufacture are also unable to determine if the trial period is nearing completion or completed without being notified by the user. Accordingly, to determine accurately when the trial period expires, the serviceman needs to check the MFP periodically at the user site, which requires cost and time. The serviceman must similarly visit the user site to determine the frequency in which the trial function or functions are being used.

It would be desirable to have a trial system that improved the ability to monitor the use of the trial function and to detect the end of the trial period.

### SUMMARY OF THE INVENTION

According to an aspect of the invention, an image forming apparatus and method for collecting information including an amount of use of the trial function during a trial period, generating a notification including the collected information at a predetermined time, and sending the notification to a predetermined location. As an example, trial period is a specified amount of time, or a number of uses of the trial function or a specified number of pages.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a perspective view of a hardcopy device consistent with the present invention.

FIG. 2 is a plan view of an exemplary control panel for the hardcopy device of FIG. 1.

FIG. 3 is a block diagram of an exemplary control circuit for the hardcopy device of FIG. 1.

FIG. 4 is a flow diagram of a trial function processing consistent with the present invention.

FIG. 5 is a block diagram of a network of hardcopy devices consistent with the present invention.

FIG. 6 is a flow diagram of a trial use notification process consistent with the present invention.

### DETAILED DESCRIPTION OF PREFERRED EMBODIMENT

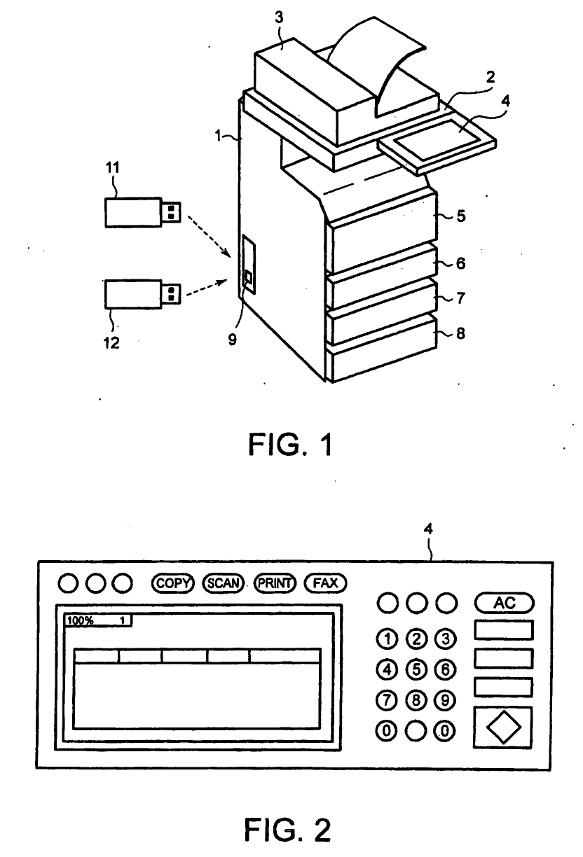

FIG. 1 is a perspective view of a hardcopy device consistent with the present invention. The hardcopy device is preferably an MFP or other type of device combining multiple functions, such as printing, copying, scanning, faxing, and document management. As shown in FIG. 1, a document table 2 is installed on top of a main body 1. A document feeder 3, including an ejection tray, is installed on the document table 2 and can be freely opened and closed. A control panel 4 is positioned at approximately the same height as the document table 2 and is configured to receive inputs for setting operating conditions of various functions performed by the hardcopy device. An exemplary plan view of the control panel 4 is shown in FIG. 2.

Paper supply cassettes 5-8 are installed n the lower part of the main body 1. A USB interface 9 for inserting and connecting a print enable key 11 or a scan enable key 12 is installed on a side of the main body 2. The print enable key 11 and the scan enable key 12 are exclusive keys provided by a manufacturer of the hardcopy device or a sales agent to permit the use of a function for a trial period. Each exclusive key has a built-in memory for storing code to enable the corresponding function in response to a password input from the control panel 4. Accordingly, to enable a trial function, the manufacturer or sales agent provides the user with the password.

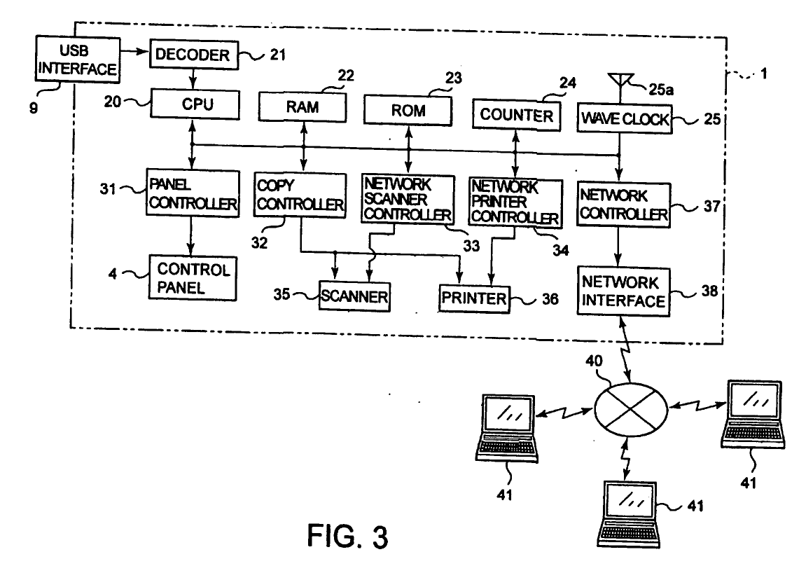

FIG. 3 is a block diagram of an exemplary control circuit for the hardcopy device of FIG. 1. The control circuit, located inside the main body 1 of the hardcopy device, includes a CPU 20, which is coupled to a decoder 21, a RAM 22, a ROM 23, a counter 24, a wave clock 25, a panel controller 31, a copy controller 32, a network scanner controller 33, a network printer controller 34, and a network controller 37.

The decoder 21 reads a code from the print enable key 11 or the scan enable key 12 inserted and connected to the USB interface 9 and decodes the code. The result of the decoding is provided to the CPU 20. The RAM 22 stores the data of the decoded code, a preset value N for printing a number of times P, and a preset value S for scanning a number of times L. ROM 23 stores various kinds of control programs necessary for the operation of the main body 1. The counter 24 counts the number of times P for printing and the number of times L for scanning during the trial period of use. The wave clock 25 is coupled to an antenna 25a, measures the current time, and successively updates the current time in response to a standard time wave received by the antenna 25a.

The panel controller 31 controls the control panel 4. The copy controller 32 controls the copy function using a scanner 35 and a printer 36. The network scanner controller 33 controls a network scanning function using the scanner 35. The network printer controller 34 controls the network print function (including the fax function) using the printer 36. The network controller 37 controls data transmission from and reception by the hardcopy device via a network interface 38. The network interface 38 includes, for example, a LAN board or a fax modem and is connected to one or personal computers 41, which are user terminals, via an external communication line 40.

The CPU 20 is configured to enable the setting of a trial period of use of a function, such as a network scan function or a network print function. The network scan function enables an image read by the scanner 35 to be e-mailed to one or more recipients via the network interface 38 and the external communication line. The network print function enables an image read by the scanner 35 to be printed. Other trial functions include, for example, a network fax function. The network fax function, in similar fashion to the network scan function, enables a fax image received by the hardcopy to be e-mailed to one or more recipients via the network interface 38 and the external communication line.

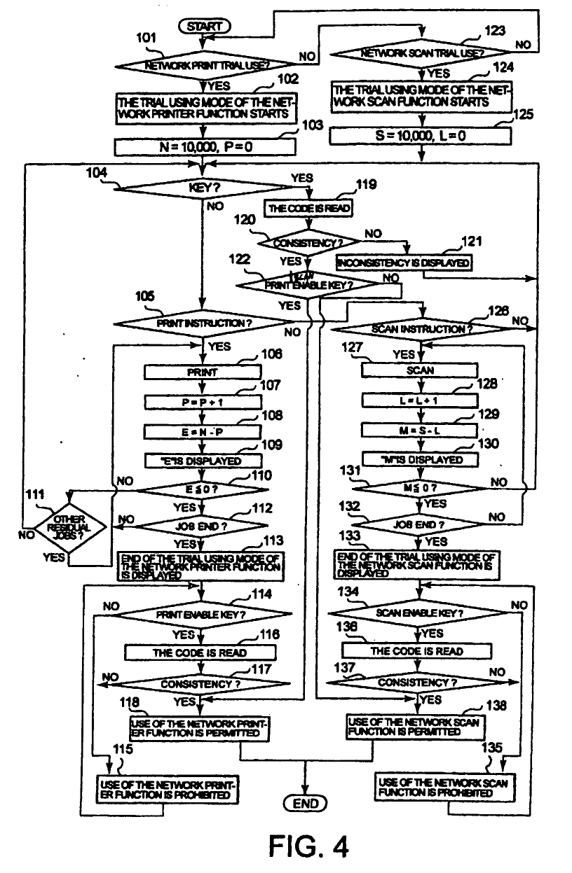

FIG. 4 is a flow diagram of a trial function processing consistent with the present invention. In FIG. 4, processing is shown for the trial functions of a network scan and a network print. It should be understood, however, that the processing is also applicable to other trial functions that may be implemented in the hardcopy device. As shown in FIG. 4, a check is made to determine if a request for a network print trial has been input via the control panel 4 (step 101). If so, a trial use mode of the network print function is started in the main body 1 according to the input (step 102). The request for the network print trial can be input by a serviceman or network administrator present at the hardcopy device. The trial preset value N of the network print function can be set to, for example, 10,000 sheets, and the counter 24, which counts the number of times P for printing, is initialized to 0 (step 103).

If the print enable key 11 is not set (NO at step 104), then a check is made to determine if a print instruction has been input to the main body 1 from a personal computer 41 via the communication line 40 (step 105). If so, a print operation according to an image signal input from the personal computer 41 is executed by the printer 36 (step 106). In accordance with this print operation, the number of times P for printing counted by the counter 24 is incremented by 1 (step 107). In addition, the number of times P for printing is subtracted form the trial preset value N to obtain the residual preset value E (step 108). The obtained residual trial preset value E is displayed on a display area of the control panel 4 with a message indicating the remaining number of sheets in the trial (step 109). The message on the display informs the user of the hardcopy device of the remaining number of sheets in the trial.

A check is made to determine if the trial preset value E has become 0 (step 110). If not, a check is made to determine if there are any other print jobs to finish (step 111). If so, then steps 106 to 109 are repeated for the other print jobs. If the trial preset value E has become 0 (YES at step 110), a check is made to determine if the print job is finished (step 112). If so, then the trial period for using the network print function is finished. A message indicating that the trial period has finished can be displayed on the control panel 4 (step 113). At the end of the trial period, a check is made to determine if the print enable key 11 is inserted and connected to the USB interface 9 (step 114). If not, continued use of the network print function is prohibited (step 115).

At the end of the trial period of using the network print function, a user desiring to continue to use the network print function can purchase a print enable key 11. The print enable key 11 includes an identification code intrinsic to the main body 1 stored together with a printable code as a condition for permitting use. If the print enable key 11 is inserted and connected to the USB interface 9 (YES at step 114), then a code is read from the print enable key 11 and decoded (step 116). A check is made to determine if the decoded result matches the identification code intrinsic to the main body 1 and the printable code (step 117). If there is a match, then the subsequent use of the network print function is permitted (step 118).

If during the trial use of the network print function the print enable key 11 is inserted and connected to the USB interface 9 (YES at step 104), then the code is read from the print enable key 11 and decoded (step 119). A check is made to determine if the decoded result matches the identification code intrinsic to the main body 1 and the printable code (step 120). If there is not a match, then a message is displayed in the display area of the control panel 4 indicating the lack of a match (step 121). In response to the message, a user can change the print enable key 11 to a proper one that is inserted and connected to the USB interface 9. If there is a match, a check is made to determine if the print enable key 11 is reset (step 122). If so, then the subsequent use of the network print function is permitted (step 118).

If there is no request for a trial use of the network print function (NO at step 101), then a check is made to determine whether there is a request for a trial use of the network scan function (step 123). If so, a trial use of the network scan function is started in the main body 1 in accordance with the request (step 124). The request for the network scan trial, like the request for the network print trial, can be input by a serviceman or network administrator present at the hardcopy device. The trial preset value S of the network scan function can be set to, for example, 10,000 sheets, and the counter 24, which counts the number of times L for scanning, is initialized to 0 (step 125).

If the scan enable key 12 is not set (NO at step 104), then a check is made to determine if a scan instruction has been input to the main body 1 (step 126). If so, a scan operation is executed by the scanner 35 according to an operation from the main body 1 (step 127). In accordance with this can operation, the number of times L for scanning counted by the counter 24 is incremented by 1 (step 128). In addition, the number of times L for printing is subtracted form the trial preset value S to obtain the residual preset value M (step 129). The obtained residual trial preset value M is displayed on a display area of the control panel 4 with a message indicating the remaining number of sheets in the trial (step 130). The message on the display informs the user of the hardcopy device of the remaining number of sheets in the trial.

A check is made to determine if the trial preset value M has become 0 (step 131). If so, a check is made to determine if there are any other scan jobs to finish (step 132). If so, then steps 127 to 130 are repeated for the other scan jobs. If not, then the trial period for using the network scan function is finished. A message indicating that the trial period has finished can be displayed on the control panel 4 (step 133). At the end of the trial period, a check is made to determine if the scan enable key 12 is inserted and connected to the USB interface 9 (step 134). If not, continued use of the network scan function is prohibited (step 135).

At the end of the trial period of using the network print function, a user desiring to continue to use the network print function can purchase a scan enable key 12. The scan enable key 12 includes an identification code intrinsic to the main body 1 stored together with a scannable code as a condition for permitting use. If the scan enable key 12 is inserted and connected to the USB interface 9 (YES at step 134), then a code is read from the scan enable key 12 and decoded (step 136). A check is made to determine if the decoded result matches the identification code intrinsic to the main body 1 and the scannable code (step 137). If there is a match, then the subsequent use of the network scan function is permitted (step 138).

If during the trial use of the network scan function the scan enable key 12 is inserted and connected to the USB interface 9 (YES at step 104), then the code is read from the scan enable key 12 and decoded (step 119). A check is made to determine if the decoded result matches the identification code intrinsic to the main body 1 and the scannable code (step 120). If there is not a match, then a message is displayed in the display area of the control panel 4 indicating the lack of a match (step 121). In response to the message, a user can change the scan enable key 12 to a proper one that is inserted and connected to the USB interface 9. If there is a match, a check is made to determine if the scan enable key 12 is reset (step 122). If so, then the subsequent use of the network print function is permitted (step 138).

In addition to a regularly used copy function, specialized functions such as the network print and network scan functions can be used on a trial basis. By using the functions on a trial basis, users of the hardcopy device can determine whether the functions are useful and decide whether to, if payment is required, to take on the expense for continuing to use the function. If the user does decide to continue to use the function, the print enable key 11 and the scan enable key 12 allows for manufacturers and retailers to provide an effective way to users to pay for the use of such specialized functions.

In the trial use, as described above, the limitation on the trial period related to a specified number of sheets or pages generated by the trial function. Instead of specifying the number of sheets, however, the trial period can be limited to a specified timer period, such as a certain number of days, weeks, or months. Alternatively, the trial period can be limited by the number of actual uses of the function. For example, the network print function can be used 100 times, i.e., for 100 separate network print jobs, regardless of the number of pages generated by each particular use of the function.

In the above described trial use system, the trial function is enabled by a serviceman or network administrator at the beginning of the trial period. In addition, to continue to use the trial function when the trial period ended, the user can purchase the print enable key 11 or the scan enable key 12. It is possible, however, for the function to continue to be used without the purchase of such a key. For example, at the end of the trial period, the user can contact the manufacturer or serviceman, indicating a desire to continue to use the function, who then enables the continued use of the function. To assist with the evaluation of the trial use and the potential continued use of the function, it is desirable to keep the serviceman or manufacturer updated regarding the use and the end of the trial period.

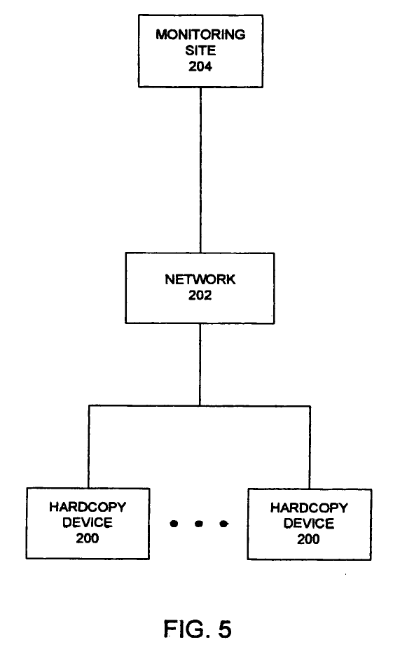

FIG. 5 is a block diagram of a network of hardcopy devices consistent with the present invention. As shown in FIG. 5, the network includes a plurality of hardcopy devices 200, a network 202, and a monitoring site 204. Each hardcopy device 200 is connected to the network 202, as is the monitoring site 204. The network 202 may be implemented as a local network, such as a LAN, or as a public network, such as the Internet. Although only two hardcopy devices 200 and one monitoring site 204 are shown, it should be understood that the system may include any number of hardcopy devices 200 and monitoring sites 204.

The hardcopy device 200 is a device which can generate a reproduction of an electronic document, such as a printer, a multi-function peripheral (MFP), or any other functional device that is capable of generating hardcopies of documents or files. In addition, each hardcopy device 200 is capable of performing one or more trial functions. The trial functions include, for example, the network scan function, the network print function, and network fax function.

Each hardcopy device 200 also includes data recorders, such as counters, to keep track of the trial functions being used on the hardcopy device. The type of data recorded for each trial function includes, for example, the number of uses or jobs involving the function, the date/time the function was used, and the amount of pages or sheets involved in each use of the function. In addition to recording data regarding each use of the trial function, each hardcopy device 200 maintains a recorder or counter for the trial period associated with each trial function. The trial period can be for a particular number of uses; such as 100, for a particular number of pages or sheets, such as 10,000, or for a particular time period, such as 30 days. For the particular number of uses or number of pages or sheets, the trial period counter can be initialized to zero and count up for each use or each page/sheet. Alternatively, the trial period counter can be initialized to the trial period amount, which is deducted for each use or each page/sheet. For the particular time, the trial period counter can count up or down for the complete trial period.

In addition to recording information about each trial use and maintaining a trial period counter, each hardcopy device 200 includes a capability for generating a notification message, such as an e-mail message, regarding the trial use of one or more functions on the hardcopy device 200. The notification message preferably includes an identification of the hardcopy device 200 itself (i.e., an identifier such as a URL, another unique network ID, or a serial number of the device), information identifying the trial function or functions operating on the hardcopy device 200, information identifying the trial period for the trial function including the original term and the remaining term, if any, and information identifying the use of the trial function, such as that recorded by the data recorders or counters in the hardcopy device 200. The formatting of the notification can be standardized, such as by including predetermined fields for each piece of information. For example, the message can have a field for the ID of the hardcopy device 200 and respective fields for each trial function including the trial period term, the remaining trial term, and the use counters. The formatting of the message is preferably configured to enable a receiver of the message to know the format ahead of time, thus being able to recognize the fields automatically. The notification message can be sent over the network 202 to the monitoring site 204. If the notification message is implemented as an e-mail, then the message can be sent to the monitoring site 204 via one or more mail servers.

The monitoring site 204, which may be a PC or a server, includes a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the monitoring site 204 provides a two-way data communication coupling via a network link to the network 202. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 202.

If the network 202 is implemented as the Internet, the monitoring site 204 can transmit a requested code for an application program through the Internet, an ISP, the local network and the communication interface. The received code can be executed by the CPU in the workstation or server as it is received, stored in the storage device, or stored in some other non-volatile storage for later execution. In this manner, a user at the workstation or server may obtain application code in the form of a carrier wave.

The monitoring site 204 can be located, for example, at the site of the serviceman, a salesperson that sells devices like the hardcopy device 200, or at the manufacturer of the hardcopy device. In response to the notification message received from the hardcopy device, the serviceman or other personnel can review the message and be able to see which hardcopy device 200 has sent the message and how each trial function is being used, such as frequency of use (i.e., number of times used over a period of time) and volume of use (i.e., amount of pages/sheets used over a period of time). In addition, the serviceman or other personnel can see how much of the trial period, if any, remains to use the trial function. Accordingly, if the trial period has ended or is close to ending, the serviceman can go to the site of the hardcopy device 200 and disable the trial function or re-enable it in a manner desired by the user of the hardcopy device 200.

In operation, workstations (not shown) communicate with the hardcopy devices 200 via the network 202 or via a more direction connection, such as by USB. This communication enables the workstations to request the hardcopy devices 200 to perform a function, such as print a document, send or receive a fax, or a trial function.

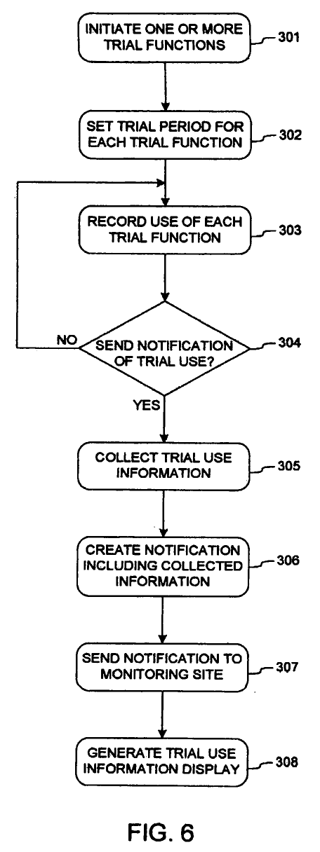

FIG. 6 is a flow diagram of a trial use notification process consistent with the present invention. For the purposes of the following description, the process is described in reference to one hardcopy device 200. It should be understood, however, that the process can be implemented on any of the hardcopy devices 200. As shown in FIG. 6, one or more trial functions are initiated on the hardcopy device 200 (step 301). As described above, the trial functions include, for example, a network print function, a network scan function, and network fax function. To initiate the trial functions, a serviceman or network administrator can configure the hardcopy device 200 to have one or more trial functions enabled. For example, the serviceman can use an administrative mode or some other protective mode of the hardcopy device 200 to initiate the trial functions.

For each of the initiated trial functions, a trial period is set (step 302). The trial period can be for a particular number of uses, a particular volume, such as a number of pages or sheets, or a particular time period. The type of trial period (e.g., use, volume, or time) may be selected according to the type of trial function, at the discretion of the serviceman or salesperson, or at the request of the user. The setting of the trial period can be effected at the same time as the initiation of the trial function. For the particular number of uses or number of pages or sheets, the trial period counter can be initialized to zero and count up for each use or each page/sheet. Alternatively, the trial period counter can be initialized to the trial period amount, which is deducted for each use or each page/sheet. For the particular time, the trial period counter can count up or down for the complete trial period. Once the trial function is initiated and the trial period is set, the users of the hardcopy device 200 can begin to use the trial function.

While the trial period is in effect, the use of each trial function is recorded (step 303). Each hardcopy device 200 includes data recorders, such as counters, to keep track of the trial functions being used. The type of data recorded for each trial function includes, for example, the number of uses or jobs involving the function, the date/time the function was used, and the amount of pages or sheets involved in each use of the function. The recorded data, including the data in the counters, can be maintained in a memory, such as an NVRAM or hard disk, within the hardcopy device 200. Alternatively, it can be maintained at a workstation or server coupled to the hardcopy device, either directly or via a network connection.

In addition to recording the use of the trial function, a check is made to determine whether to send a notification message (step 304). The check can be made each time the trial function is used. Alternatively, the check can be made at regular intervals, such as each hour or once a day. To determine whether a notification message should be sent, the hardcopy device 200 checks to see if the trial period for any trial function has expired or is within a predetermined threshold of expiring, such as one day from the end of the trial, fewer than five uses remaining, or fewer than fifty pages remaining. If so, then a determination is made to send a notification message. It is also possible to configure the hardcopy device 200 to send notification messages at regular intervals, such as once a day or once a week, or after reaching certain milestones, such as after predetermined increments of the trial period. For example, a determination can be made to send a notification message after each quarter of the trial period has passed.

If no determination is made to send a notification message, then the hardcopy device 200 continues to enable the trial function and to record the use of each trial function, as set forth in step 303. If a determination is made to send a notification message, however, then the hardcopy device 200 collects use information for each trial function (step 305). The use information includes the information recorded for each trial function, such as the number of uses or jobs involving the function, the date/time the function was used, and the amount of pages or sheets involved in each use of the function. The collected information can include the information recorded for each trial function that is enabled. Alternatively, the information can be collected just for a particular trial function. For example, if a notification message is to be sent in response to the expiration of the trial period for one trial function, but the trial period for other trial functions has not yet expired, then the hardcopy device 200 may collect information only for the trial function with the expired trial period.

The hardcopy device 200 creates a notification message that includes the collected information (step 306). The notification message can be implemented, for example, as an e-mail or other message format that can be sent from the hardcopy device 200 to another device over a communication line, such as a network. In addition to the collected information, the notification message preferably includes an identification of the hardcopy device 200 itself, such as a URL or serial number, information identifying the trial function or functions corresponding to the collected information, and information identifying the trial period for the trial function including the original term and the remaining term, if any. As described above, the formatting of the notification can be standardized, such as by including predetermined fields for each piece of information so as to enable a receiver of the message to know the format ahead of time and be able to recognize the fields automatically.

The hardcopy device 200 sends the notification message to the monitoring site 204 (step 307). The notification message is sent over the network 202 to the monitoring site 204. The monitoring site 204 receives the notification message and uses the notification message to generate a display regarding the use of the trial functions (step 308). The message can be displayed on, for example, a CRT or LCD display located at the monitoring site 204. To generate the display, the monitoring site 204 analyzes the content of the notification message. In particular, the monitoring site 204 is preferably configured to understand the format of the received message and to extract the use information for each trial function automatically based on the predetermined format. The predetermined format may have a specific field for each type of information for each trial function. For example, the first field of every message may be the number of uses of a first trial function, and the second field of every message may be the number of uses of a second trial function. A file describing the link between the field and the information it contains may be stored at the monitoring site 204 and referenced to determine how to display the information regarding the use of each trial function.

With the display of the information of the use of each trial function for a particular hardcopy device 200, the serviceman or other personnel at the monitoring site 204 can assess the use of the trial functions of the hardcopy device 200 without visiting the site of the hardcopy device 200. Based on the assessment, it is possible to determine how frequently or not each trial function is used. As a result, the serviceman or salesperson can identify which trial functions would be desirable for the user to continue to use. In addition, with the display of the status of the related trial period for each trial function, the serviceman can recognize the end of the trial period without having to contact the user and without having to visit the site of the hardcopy device 200.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for providing notification of expiration of use of a trial function implemented on a hardcopy device, comprising:
collecting information including an amount of use of the trial function during a trial period;
generating a notification including the collected information at a predetermined time; and
sending the notification to a predetermined location.

2. A method according to claim 1, wherein the predetermined time is at an expiration of the trial period.

3. A method according to claim 1, wherein the predetermined time is at a predetermined interval after initiating the trial function.

4. A method according to claim 1, wherein the predetermined time is within a predetermined threshold.

5. A method according to claim 1, wherein the trial period is a specified amount of time.

6. A method according to claim 1, wherein the trial period is a specified number of uses of the trial function or a specified number of pages.

7. A method according to claim 1, wherein the trial function is at least one of a network print function or a network scan function.

8. A method according to claim 1, wherein the collected information includes a number of times the trial function is used and a number of pages used in performing the trial function.

9. A method according to claim 1, further comprising generating a display based on the collected information in the notification.

10. A method according to claim 1, wherein the notification has a predetermined format with a plurality of fields, each field having a predetermined association with a particular trial function and corresponding to a particular use value.

11. A method according to claim 1, wherein the notification includes an identifier of the hardcopy device.

12. A method according to claim 1, wherein the notification includes information regarding a plurality of trial functions.

13. A method according to claim 1, further comprising enabling the trial function to be used by the hardcopy device, wherein the step of enabling includes setting the trial period for the use of the trial function.

14. A method according to claim 1, wherein the notification is an electronic mail message, and the predetermined location is an electronic mail address.

15. A method according to claim 1, further comprising recording information about each use of the trial function, the information recording including a number of times the trial function has been used.

16. A method according to claim 15, further comprising updating the trial period in accordance with the use of the trial function.

17. A method according to claim 1, further comprising checking whether to send the notification.

18. A method according to claim 17, wherein the step of checking is performed each time the trial function is used.

19. A method according to claim 17, wherein the step of checking is performed every predetermined interval of time.
